(19) United States
(12) Patent Application Publication
(10) Pub. No.: US 2010/0121867 A1
(43) Pub. Date: May 13, 2010

(54) SYSTEM AND METHOD FOR DISTRIBUTING EDITORIAL CONTENT ON THE WEB WITH REFERENCES AND INDICATORS

(76) Inventor: Karl GOSEJACOB, Munich (DE)

Correspondence Address: LADAS & PARRY LLP, 26 WEST 61ST STREET, NEW YORK, NY, 10023, US

(21) Appl. No.: 12/554,518

(22) Filed: Sep. 4, 2009

Related U.S. Application Data
(60) Provisional application No. 61/113,643, filed on Nov. 12, 2008.

(51) Int. Cl. G06F 17/30

(52) U.S. Cl. 707/758; 707/E17.01

(57) ABSTRACT

Publishers of editorial content distribute to Web pages at first references to or indicators for editorial content as links, rather than the content itself, when and if the interest targeted by the editorial content matches the interest targeted by the Web pages, the respective editorial content being rendered subsequently on request by the link, together with relevant ads.

This application claims the benefit of U.S. Provisional Application No. 61/113,643, filed on Nov. 12, 2008 and incorporates the same by reference.

### BACKGROUND OF THE INVENTION

1. Field of the Invention

The present invention relates generally to the Internet or World Wide Web (hereinafter “the Web”), and, more particularly, to publishing editorial content thereon.

2. Background Art

Distributing advertisements, ads for short, to Web pages has emerged into a significant market. In this market the AdSense program offered by Google Inc.® claims placing relevant ads on target Web pages based on a comparison between targeting information for the ads and for the content of respective Web pages. With the AdSense business method Google has transferred the keyword-targeted AdWords approach from their Web search engine to any Web page, i.e., from targeting search queries to targeting any content. With both business models ads revenue generation is not tied to editorial content production and publication as is in traditional media publishing.

Business methods such as AdSense and AdWords, combined with the ongoing shift from printed to online media usage, are threatening publishers of editorial content, even those newspaper or magazine publishers who are reaching significantly more audiences online than with their printed media. Business methods such as publishing articles simultaneously in printed media and on the Web with the same publishing brand, and business models such as editorial content syndication seem to be necessary yet insufficient counter measures: Syndication involves a tedious process of choosing relevant articles. With simultaneous Web publishing of newspaper and magazine articles the reach of new audiences is limited by the image of the editorial content brand.

The threat to publishers is concisely summed for the case of newspapers in a New York Times article of 7 Feb. 2008 entitled An Industry Imperiled by Falling Profits and Shrinking Ads: “The paradox is that more people than ever read newspapers, now that some major papers have several times as many readers online as in print. And papers sell more ads than ever, when online ads are included. But for every dollar advertisers pay to reach a print reader, they pay about 5 cents, on average, to reach an Internet reader. Newspapers need to narrow that gap, but the rise in Internet revenue slowed sharply last year.”

At the same time, there is an abundance of user-generated content on the Web, e.g., with social networks. According to a March 2009 Nielsen report entitled Global Faces and Networked Places “Social network and blogging sites now account for almost 10% of all Internet time yet remains, with a few exceptions, a largely un-monetized form of media.” The report notes that such Web sites “ . . . offer the opportunity to promote content to a wider audience across the web.” The report also finds that “ . . . consumers are actually growing less tolerant to advertising on social media.” The report concludes that advertisers and social networks “ . . . will reap significant rewards if they can discover the magic recipe for advertising successfully on social networks . . . ”

There exists, therefore, a need to provide methods and systems for distributing editorial content to a plurality of Web pages such that the editorial content enriches the content of respective Web pages, thus enhancing the user experience with respective Web pages, while maintaining both the brand of the editorial content and the related advertising business opportunities for the publisher of the editorial content

### BRIEF DESCRIPTION OF THE INVENTION

The present invention meets these and other needs by providing methods, systems, apparatuses, and computer program products for distributing to Web pages at first references to or indicators for editorial content as links, rather than the content itself, if and when the interests targeted by the editorial content and by the Web pages match, and rendering respective editorial content on subsequent request by the links, together with relevant ads

In accordance with one embodiment of the present invention there is provided a method for distributing on the Web references to or indicators for editorial content in relation to an inventory of editorial content. The method includes (1) requesting editorial content with information for a targeted interest when a Web page is rendered, (2) comparing the targeting information for the Web page with targeting information for editorial content in the inventory, (3) responding with references to or indicators for editorial content if targeted interests match by placing the references or indicators on the Web page as links for request, and (4) rendering editorial content on request by the links, together with relevant ads by comparing targeting information for the rendered editorial content with targeting information for ads.

In accordance with another embodiment of the present invention there is provided a method for displaying on the Web references to or indicators for editorial content. The method includes (1) receiving a request for a Web page, (2) rendering the Web page, (3) transmitting a request for editorial content, the request including targeting information for the Web page, (4) receiving references to or indicators for editorial content, the references or indicators resulting from a comparison of the targeting information for the Web page with targeting information for stored editorial content, (5) displaying the references or indicators on the Web page as links, and (6) rendering editorial content on request through the links, together with received ads resulting from a comparison of targeting information for the rendered editorial content with targeting information for ads.

In accordance with another embodiment of the present invention there is provided a method for distributing for the Web references to or indicators for editorial content in relation to stored editorial content. The method includes (1) receiving a request for editorial content, the request including targeting information for a Web page, (2) comparing the targeting information for the Web page with targeting information for the stored editorial content to obtain references to or indicators for editorial content, (3) transmitting the references to or indicators for editorial content to be displayed as links, (4) receiving a request for editorial content associated with a link, and (5) transmitting the editorial content associated with the link, together with received ads resulting from a comparison of targeting information for the associated editorial content with targeting information for ads.

In accordance with another embodiment of the present invention, there is provided a method for serving ads to be displayed with editorial content on the Web. The method includes (1) receiving a request for ads to be rendered with editorial content, (2) comparing targeting information for the editorial content with targeting information for stored ads, and (3) transmitting relevant ads obtained as a result of said comparing step.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings.

FIG. 1 illustrates a state diagram of systems interacting in placing references to or indicators for relevant editorial content on a Web page as links, and rendering respective content on request by the links, together with relevant ads.

FIG. 2 illustrates references to magazine or newspapers articles for placement on a Web page as links.

FIG. 3 illustrates indicators for brands mentions in editorial content for placement on a Web page as links.

FIG. 4 illustrates indicators for sources of editorial content mentioning a given brand for placement on a Web page as links.

FIG. 5 illustrates an indicator for brand mention with a representation for a document in a Web index, the indicator being linked to the indexed document, and a hint at the brand mention rendered together with the indexed document.

FIG. 6 illustrates an example of a computer system for use with the present invention.

### DETAILED DESCRIPTION

The present invention is directed to methods, systems, apparatuses, and computer program products, e.g., data formats or systems components, for distributing references to and indicators for editorial content at first, and subsequently respective editorial content together with ads. The following description is presented to enable a person having ordinary skill in the art to implement and utilize the invention. Modifications to the disclosed embodiments will be apparent to those skilled in the art, and the general principles set forth below may be applied to other embodiments and applications. Thus, the present invention is of course not intended to be limited to the embodiments shown, and the inventor regards his invention as any patentable subject matter described.

In the following, environments in which, or with which, the present invention may operate are described in A. Subsequently, further example embodiments of the present invention are described in B. In addition, definitions of key terms for the present invention are discussed in C. Further, example implementations are described in D.

A. Operating Environments

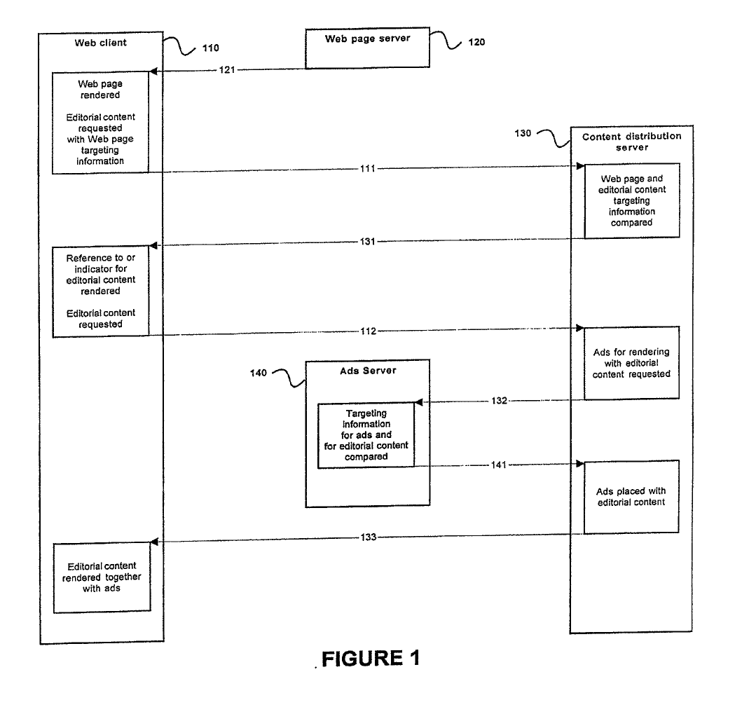

FIG. 1 is a diagram of an editorial content distributing environment according to one example embodiment. The systems operations shown are performed at runtime, i.e., this diagram of requests and responses is commutative to considerable extent. Moreover, the systems interactions may be performed equivalently with different systems and respective messages.

It will also be understood that the system of the present invention, subsystems thereof, and systems interacting therewith, may be suitably connected via data links and over an intranet or the Internet. A variety of conventional communications media and protocols may be used for data links, such as a connection to an Internet Service Provider (ISP) over a local loop as is typically used in connection with standard modem communication, cable modem, Dish networks, Integrated Services Digital Network (ISDN), Digital Subscriber Line (DSL), or various wireless communication methods.

The environment shown in FIG. 1 includes a Web client 110, being rendered with a Web page from a Web page server 120 in response 121 to any request from Web client 110. When being rendered with a Web page the client 110 sends a request 111 to a content distribution server 130 with targeting information for the Web page. The response 131 to request 111 are references to or indicators for editorial content on the content distribution server. When responding, the targeting information for the Web page sent to the server 130 has been compared with targeting information for the editorial content on the server 130, such that references or indicators are for relevant editorial content. The references or indicators are links: On request 112 of a reference or an indicator a request 132 for relevant ads is sent to an ads server 140 with targeting information for the requested editorial content. When response 133 is sent to the client 110 the targeting information for the requested editorial content has been compared with targeting information for ads on the server 140, such that request 132 is responded with relevant ads 141 for being rendered together with the requested editorial content. Moreover, when response 133 is sent, relevant ads are placed with the requested editorial content.

With regard to the comparison performed by the content distribution server 130, in one example embodiment, the result of a comparison of target information for editorial content and target information for a Web page may be considered a percentage of relevance of some editorial content in relation to the Web page. For example, let some editorial content be attributed with n keywords of targeting information and let m≦n of those keywords be attributed to the Web page. Then the fraction m/n is the percentage of relevance. Of course, editorial content and a Web page may have been complemented with targeting information by the respective publisher prior to the runtime comparison, i.e., in a batch process, as described herein. With relevant ads the numerator in the percentage of relevance can be the number of keywords of targeting information for an ad.

One example of a Web page server 120 is run for or by an owner of consumer brands, and thus Web client 110 is used by a consumer interested in the branded offerings propagated in respective Web pages. In this case Web pages would contain or would be complemented with targeting information as to consumer interest in relation to the branded offerings.

Another example of a Web page server 120 is run for creating and sharing user-generated content, e.g., in maintaining a community for questions and answers by Web users. In this case Web pages contain keywords in or as tags for user-generated content, e.g., questions and answers as targeting information.

Yet another example of a Web page server 120 is run by the publisher of a Web search engine. In this case Web pages contain search results in response to search queries.

One example of a content distribution server 130 is run for or by a publisher of newspapers or magazines, and the content to be distributed is or may be edited for newspapers or magazines. In this case editorial content would be tagged with targeting information, such as keywords for special interests. There are numerous well-known practices for such tagging, e.g., for archiving purposes.

Another example of a content distribution server 130 is run for or by the publisher of a Web search engine. In this case the editorial content comprises representations of documents in a Web index, the documents being captured by Web crawling. One representation format is given by browser title, snippet from and unified resources identifier (URI) of the document to be represented. Other representations contain the publisher or the source of the document, e.g., with search engines for news on the Web. The Web search engine may be specialized, e.g., to a special interest, such as capital goods for factory automation.

Yet another example of a content distribution server 130 is run for a by a retailer of products. In this case the editorial content comprises products information or content of products catalogues. In this case such products information already contains or would be complemented with targeting information.

In the cases of newspapers or magazines or products catalogues, the editorial content is typically edited with content management systems. Even though such systems have traditionally been for preparing a printing process, state-of-the-art systems use Internet or Web technology, e.g., Extensible Markup Language (XML) in the case of Adobe® InDesign®. Based on such technologies, editorial content can be further processed more or less automatically for publication on the Web. This would be utilized in rendering editorial content in response 133 to request 111.

Economically, in one example embodiment the environment may involve, in principle, three parties or business roles: The publisher of Web pages with Web page server 120, the publisher of editorial content with content distribution server 130, and the ads distributing agent with ads server 140. In one business scenario, the editorial content publisher would have contracts with the Web pages publisher and the ads distribution agent. The editorial content publisher would supply the Web pages publisher with executable code for implementation in respective Web pages, such that request 111 is performed. There are various client or server side methods and technologies available for such systems interactions on the Web. The Web pages publisher would be compensated by the editorial content publisher with a share of ad revenues, the ad revenues being achieved by placing ads with requested editorial content. As in traditional media the editorial content publisher predominantly orchestrates the business environment, not the ads agent. For the present implementation to be implemented effectively, the three parties characterized should agree on interfaces for the operations described in FIG. 1. Technologically, standards for such interfaces are provided by the documentation of the Internet Engineering Task Force (IETF). The three parties characterized do not have to exchange their know-how as to matching targeting information—for Web pages, editorial content, and ads, respectively.

The role of the editorial content publisher may be shared among several such publishers, i.e., the role may be taken by a contractual network or joint-venture of such publishers. The role of the Web pages publisher may as well be shared among several publishers, e.g., may be taken by an advertising network.

B. Example Embodiments of References to and Indicators for Editorial Content

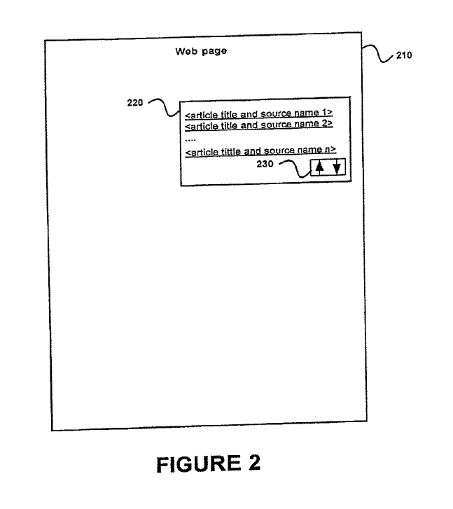

FIGS. 2-5 illustrate references to or indicators for editorial content to be distributed on the Web, according to example embodiments. In one general example, such references would be implemented as Inline Frame (IFrame) widgets.

FIG. 2 illustrates references 220 to articles as for magazines or newspapers on a Web page 210 rendered by a Web page server 120. In one example the references comprise article titles and sources names (e.g., Article Title: Carly Smithson Leaves American Idol; Source Name: People). The references are for browsing with buttons 230. As indicated in the illustration, each reference is a link to respective editorial content. In this example, an article would be rendered on request of the link. In another example, the references may also comprise publisher names and URI. References 220 may be ranked in accordance with a percentage of relevance similar to as described above.

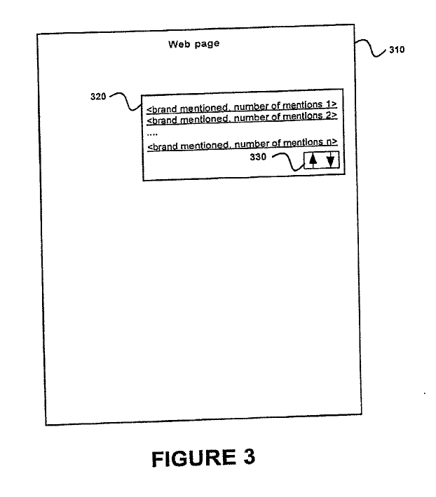

FIG. 3 illustrates indicators 320 for brand mention in editorial content (e.g., GUCCI) to be distributed by a server 130 on a Web page 310 rendered by a Web page server 120. In one example the indicators comprise brand names and number of mentions, ranked by number of mentions. The indicators are for browsing with buttons 330. As indicated in the illustration, each indication is a link. In one example the editorial content comprises a Web index, and each indicator is linked to a list of documents in the Web index mentioning the respective brand. Several mentions of a brand in one document would be counted as one mention by a document in the index. In another example, brand mentions may be ranked according to a principal Eigenvector of the matrix of coinciding mentions of pairs of brands in editorial content. An indexed document can be indexed together with the brands mentioned in the document based on identifications for a brand. Brand identifications can be edited with a brands management system, i.e. set, refined, altered or deleted. A brands management system may comprise a database representing the relationships between brand names, market segments, brand owners, claims, or additional brand attributes which distinguish one brand from other brands (e.g., GUCCI and luxury goods). With each brand the attributes would be used in establishing the Web index such that documents are indexed together with the brands mentioned. A brand may remain non-distinctive even with brand attributes; in such cases, a brand would be excluded from being indexed together with a document mentioning the brand name. A brands management system would interface with the indexing system for the Web index.

Eigenvector-based rankings with Web indices are discussed, for example, in the article entitled The 25,000,000,000 Eigenvector: The Linear Algebra behind Google, Bryan et al., SIAM Review, Vol. 48, No. 3, pp. 569-581, Society for Industrial and Applied Mathematics (SIAM), 2006).

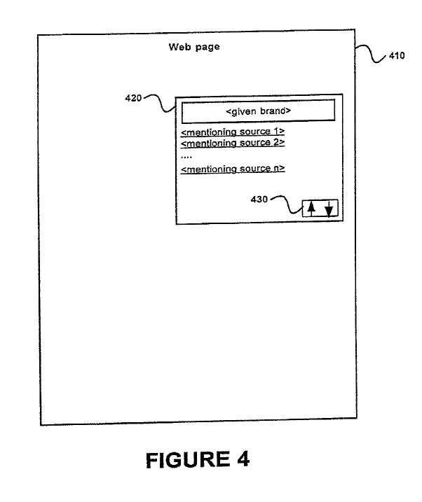

FIG. 4 illustrates indicators 420 for mentions of a given brand to be distributed by a server 130 on a Web page 410 rendered by a Web page server 120. In one example, the given brand is represented by a logo. The indicators are for browsing with buttons 430. As indicated in the illustration, each indicator is a link. In one example, the editorial content comprises a Web index and each indicator is linked to a list of documents mentioning the given brand, in which the linked document mentioning the brand is marked. Sources mentioning a given brand with indicators 420 may be ranked according to a percentage of relevance similar to as described above.

Sources may be identified by source names or unified resource identifiers (URI), and the sources may be edited with a sources management system, i.e. set, refined, altered or deleted. A sources management system may comprise a database representing the relationships between source names, market segments, source publishers, or additional source attributes which distinguish one source from other sources, e.g., People and celebrity magazines. A sources management system would interface with the indexing system for the Web index.

Attributes to be used in references to or indicators for editorial content may be edited with an attributes management system, i.e. set, refined, altered or deleted, and documents containing such attributes may be indexed together with the attributes. An attributes management system may comprise a database representing relationships between editorial content and content description terms which do not already occur in the content, e.g., automotive with content referring to specific cars. An attributes management system would interface with the indexing system for the Web index.

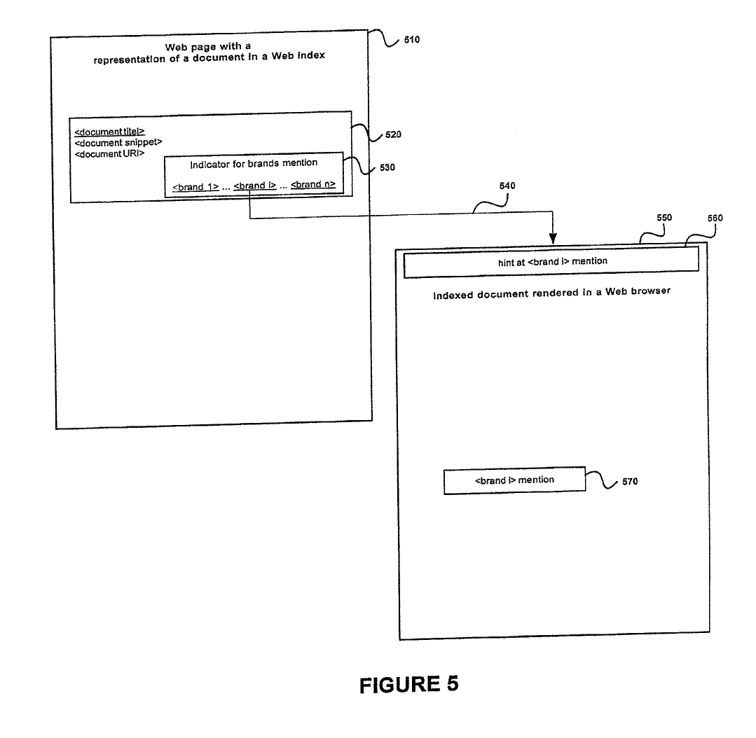

FIG. 5 illustrates an indicator 530 for brands mention with the representation 520 of a document in a Web index on a Web page 510 to be rendered by a Web server 120. In one example the Web page is a results page of a search engine. In general, the mention of a brand name in an indexed document would only show in a state-of-the-art representation of an indexed document if the brand name occurs in the search query. Thus, the mention of one or more brands surfaces only with the indicator 530. In one example, the indicator presents the names of the brands mentioned in the document. In another example, the indicator presents logos for the mentioned brands. As shown in the illustration each brand as presented in the indicator is a link to the mentioning document, such that on click 540 the mentioning document 550 is rendered. In one example, the document is rendered with a hint 560 at the brand mention. Textually, the hint could be, e.g., “Editorially mentioned: GUCCI.” Yet, 550 could have a graphical design as well. Additionally or in another example, the document would be rendered with a mark 570 at one or each instance of mention of the respective brand. In one business environment the indication of a brand with indicator 530 could be booked by or for the brand owner and the presentation of the brand or the click 540 would be billed. The presentation of a brand mention may as well be booked if the respective brand is the only brand mentioned in the indexed document.

C. Definitions

The term “editorial mention” is very well known inside the media industry. As discussed in a Wall Street Journal article of 9 Aug. 2004 entitled Blurring the Line: “ . . . editorial mention [is what] marketers love to have as they seek to stand out from the advertising clutter.” Yet, this must not, quoted from the same article, “ . . . blur the traditional line between editorial and advertising.” This requires editorial mention to follow journalistic principles. Academic treatment of editorial mention is rare. However, as discussed in a research article in Business Horizons, May-June 2006, 247-256, entitled Public Relations Comes of Age, and referring to product mention in the Walter Mossberg Personal Technology column in the Wall Street Journal: “No technology marketer could spend any amount of money to purchase any number of full page advertisements in the Journal that would be remotely as effective as Mossberg's thumbs up or thumbs down.” Editorial mention on TV, in movies or in videos must not be mistaken for product placement: Product placement is a form of advertisement, while editorial mention must have journalistic rationale.

The term “brand” has been defined numerously in the academic world. Yet, a practitioner's view is more relevant for the present invention. The following quotation is from an April 2004 Interbrand brochure entitled What is a Brand? “The visual distinctiveness of a brand may be a combination of any of the following: name, letters, numbers, a symbol, a signature, a shape, a slogan, a color, a particular typeface. But the name is the most important element of the brand as its use in language provides a universal reference point. The name is also the one element of the brand that should never change. All other elements can change over time . . . , but the brand name should be . . . as constant as the northern star.” With this rational, brand names and brand claims, and additional textual identifications are a solid base for detecting brand mention in editorial content.

D Example Implementation

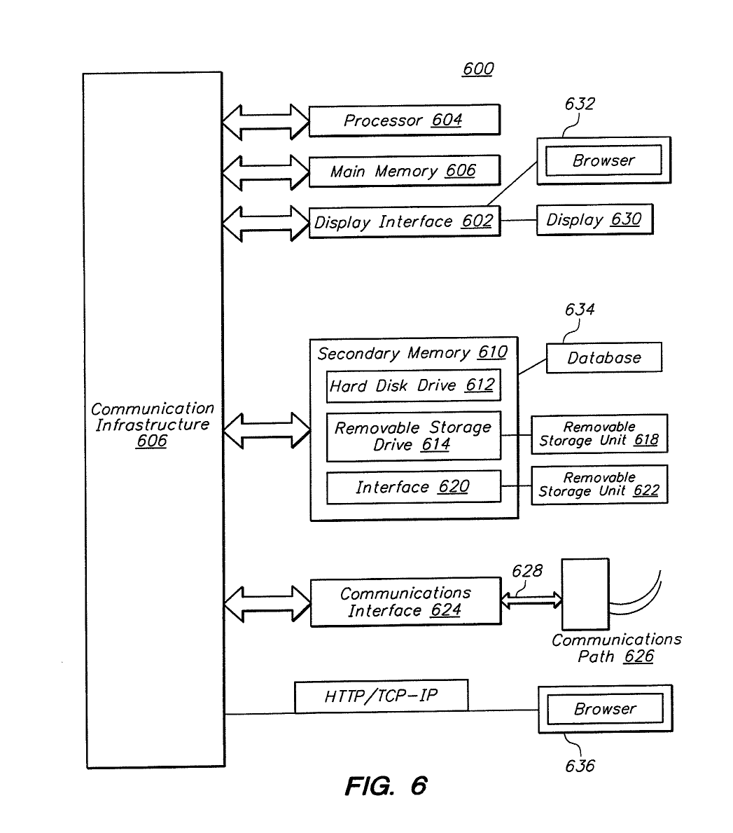

The present invention or any part(s) or function(s) thereof, including but not limited to Web page server 120, content distribution server 130, and ads server 140, may be implemented using hardware, software, or a combination thereof, and may be implemented in one or more computer systems or other processing systems. Useful machines for performing some or all of the operations of the present invention include digital computers or similar devices. In fact, in one embodiment, the present invention is directed toward one or more computer systems equipped to carry out the functions described herein. An example of such computer system 600 is shown in FIG. 6.

The computer system 600 includes at least one processor 604. The processor 604 is connected to a communication infrastructure 606 (e.g., a communications bus or a network), which is in communication with, inter alia, a browser 636 connected to an internet or intranet. Although various software embodiments are described herein in terms of this exemplary computer system 600, after reading this description, it will become apparent to a person skilled in the relevant art(s) how to implement the invention using other computer systems and/or architectures.

The computer system 600 also includes a display interface 602 that forwards graphics, text, and other data from the communication infrastructure 606 (or from a frame buffer (not shown)) for display on a display unit 630 or on a browser 632 connected to an intranet or internet. The computer system 600 also includes a main memory 608, which preferably is a random access memory (RAM), and may also include a secondary memory 610. The secondary memory 610 may include, for example, a hard disk drive 612 and/or a removable storage drive 614 (e.g., a floppy disk drive, an optical disk drive, and the like). The removable storage drive 614 reads from and/or writes to a removable storage unit 618 in a well-known manner. The removable storage unit 618 may be, for example, a floppy disk, an optical disk, and the like, which is written to and read by the removable storage drive 614. As will be appreciated, the removable storage unit 618 includes a computer-usable storage medium having stored therein computer software and/or data.

In alternative embodiments, the secondary memory 610 may include other similar devices for allowing computer programs or other instructions to be loaded into the computer system 600. Such devices may include a removable storage unit 622 and an interface 620 (e.g., a program cartridge); a removable memory chip, and an associated memory socket; and other removable storage units 622 and interfaces 620 that allow software and data to be transferred from the removable storage unit 622 to the computer system 600.

The computer system 600 may also include a communications interface 624, which allows software and data to be transferred between the computer system 600 and external devices (not shown). Examples of the communications interface 624 may include a modem, a network interface (e.g., an Ethernet card), a communications port, a Personal Computer Memory Card International Association (“PCMCIA”) interface, and the like. Software and data transferred via the communications interface 624 are in the form of signals 628, which may be electronic, electromagnetic, optical or another type of signal that is capable of being received by the communications interface 624. These signals 628 are provided to the communications interface 624 via a communications path 626 (e.g., a channel). The communications path 626 carries the signals 628 and may be implemented using wire or cable, fiber optics, a telephone line, a cellular link, a radio-frequency (“RF”) link, or the like.

As used herein, the phrases “computer program medium” and “computer usable medium” may be used to generally refer to a removable storage unit 618 used with the removable-storage drive 614, a hard disk installed in the hard disk drive 612, or the signals 628, for example. These computer program products provide software to the computer system 600. The present invention may be implemented or embodied as one or more of such computer program products.

Computer programs (also referred to as computer control logic) are stored in the main memory 608 and/or the secondary memory 610. The computer programs may also be received via the communications interface 624. Such computer programs, when executed, enable the computer system 600 to perform the features of the present invention, as discussed herein. In particular, the computer programs, when executed, enable the processor 604 to perform the features of the present invention. Accordingly, such computer programs represent controllers of the computer system 600.

In an embodiment where the present invention is implemented using software, the software may be stored in a computer program product and loaded into the computer system 600 using the removable-storage drive 614, the hard drive 612, or the communications interface 624. The control logic (software), when executed by the processor 604, causes the processor 604 to perform the functions of the present invention as described herein. In another embodiment, the present invention is implemented primarily in hardware using, for example, hardware components such as application-specific integrated circuits (“ASICs”). Implementation of such a hardware arrangement so as to perform the functions described herein will be apparent to persons skilled in the relevant art(s). In yet another embodiment, the present invention is implemented using a combination of both hardware and software. Computer modules may carry out various features of the present invention.

E. Conclusion

As noted above, the various embodiments of the present invention described above have been presented by way of example and not limitation. It will be apparent to a person skilled in the relevant arts that various changes in form and detail can be made therein (e.g., different hardware, communications protocols, and the like) without departing from the spirit and scope of the present invention. Thus, the present invention should not be limited by any of the above-described exemplary embodiments.

In addition, it should be understood that the attached drawings, which highlight the functionality and advantages of the present invention, are presented as illustrative examples. The architecture of the present invention is sufficiently flexible and configurable, such that it may be utilized (and navigated) in ways other than that shown in the drawings.

What is claimed is:

1. A method for distributing on the Web references to or indicators for editorial content in relation to an inventory of editorial content, the method comprising: requesting editorial content with information for a targeted interest when a Web page is rendered; comparing the targeting information for the Web page with targeting information for editorial content in the inventory; responding with references to or indicators for editorial content if targeted interests match by placing the references or indicators on the Web page as links for request; and rendering editorial content on request by the links, together with relevant ads by comparing targeting information for the rendered editorial content with targeting information for ads.

2. The method of claim 1, wherein the editorial content is from or is or may be for magazines or newspapers and related Web sites, or is video content, and wherein the editorial content has been processed for publication on the Web.

3. The method of claim 2, wherein references to editorial content refer to single magazine or newspaper articles, or articles on Web sites, or videos, wherein the references comprise magazines or newspapers or video names and titles or subtitles or abstracts or publisher names or authors names or illustrations or, in case of video, video stills, and wherein the references are ranked according to their relevance in relation to the targeting information of the Web page.

4. The method of claim 1, wherein indicators to editorial content list one or more brands which are mentioned in the editorial content.

5. The method of claim 4, wherein brands are identified by brand name or brand owners or brand claims or relevant markets, and wherein such identifications are edited with a brands management system.

6. The method of claim 4, wherein brands are ranked according to number of mentions in the inventory of editorial content.

7. The method of claim 4, wherein brands are ranked according to a principal Eigenvector of the matrix of coinciding mentions of pairs of brands.

8. The method of claim 1, wherein in relation to a given brand mentioned in the inventory of editorial content, the indicators list sources mentioning the brand.

9. The method of claim 8, wherein the mentioning sources are ranked according to their relevance in relation to the given brand mentioned.

10. The method of claim 8, wherein the mentioning sources are ranked according to the number of brands mentioned in the mentioning sources.

11. The method of claim 8, wherein the sources are identified by sources names or unified resources identifiers (URI), and wherein the sources are edited with a sources management system.

12. The method of claim 1, wherein the editorial content comprises products information or content of products catalogues, and wherein such content has been processed for publication on the Web.

13. The method of claim 12, wherein references comprise product brands or manufacturers brands or retailers brands or product prices or product illustrations.

14. The method of claim 12, wherein product information is ranked according to relevance as to targeting information of the Web page.

15. The method of claim 1, wherein the inventory of editorial content consists of or is contained in a Web index.

16. The method of claim 15, wherein the references or indicators are established in the crawling or indexing processes for the Web index.

17. The method of claim 15, wherein in relation to brands mentioned in editorial content the editorial mention is indicated with the representation of an indexed document.

18. The method of claim 17, wherein the editorial mention is indicated only if no other brands are mentioned.

19. The method of claim 17, wherein the editorial mention is indicated with a logo.

20. The method of claim 19, wherein the logo is a Favicon.

21. The method of claim 17, wherein the brand indication is a link to an indexed document mentioning the brand.

22. The method of claim 21, wherein linked editorial content is rendered together with a hint at editorial mention of the brand.

23. The method of claim 15, wherein a Web index is extended with documents which have not been published on the Web.

24. The method of claim 15, wherein attributes to be used in references to or indicators for editorial content are edited with an attributes management system, and wherein documents containing such attributes are indexed together with the attributes.

25. The method of claim 24, wherein the attributes comprise brands identifications or markets identifications.

26. The method of claim 1, wherein the Web page has been complemented with targeting information by a publisher.

27. The method of claim 1, wherein the targeting information of the Web page is a search query entered by a user.

28. The method of claim 1, wherein the Web page comprises user-generated questions and answers, and wherein the targeting information comprises tags for the questions and answers.

29. The method of claim 1, wherein editorial content has been complemented with the targeting information by a publisher.

30. The method of claim 29, wherein the targeting information is used in the references or indicators.

31. The method of claim 30, wherein the targeting information identifies relevant markets or market segments, and wherein the targeting information is edited with a markets management system.

32. The method of claim 29, wherein the targeting information identifies publishers of editorial content.

33. The method of claim 1, wherein the references or indicators are ranked according to a principal Eigenvector of the matrix of coinciding mentions of pairs of keywords of targeting information.

34. The method of claim 1, wherein a reference or indication is marked with an icon or a pictogram conveying the editorial content format.

35. The method of claim 34, wherein the editorial content are articles, the icon conveys lines of text, and an article is rendered on click of the icon.

36. The method of claim 34, wherein the editorial content is video, the icon is a play button, and a video is rendered on click of the icon.

37. A method for displaying on the Web references to or indicators for editorial content, the method comprising:
receiving a request for a Web page;
rendering the Web page;
transmitting a request for editorial content, the request including targeting information for the Web page;
receiving references to or indicators for editorial content, the references or indicators resulting from a comparison of the targeting information for the Web page with targeting information for stored editorial content;
displaying the references or indicators on the Web page as links; and
rendering editorial content on request through the links, together with received ads resulting from a comparison of targeting information for the rendered editorial content with targeting information for ads.

38. A method for distributing for the Web references to or indicators for editorial content in relation to stored editorial content, the method comprising:
receiving a request for editorial content, the request including targeting information for a Web page;
comparing the targeting information for the Web page with targeting information for the stored editorial content to obtain references to or indicators for editorial content;
transmitting the references to or indicators for editorial content to be displayed as links;
receiving a request for editorial content associated with a link; and
transmitting the editorial content associated with the link, together with received ads resulting from a comparison of targeting information for the associated editorial content with targeting information for ads.

39. A method for serving ads to be displayed with editorial content on the Web, the method comprising:
receiving a request for ads to be rendered with editorial content;
comparing targeting information for the editorial content with targeting information for stored ads; and
transmitting relevant ads obtained as a result of said comparing step.
